(19) United States
(12) Patent Application Publication
(10) Pub. No.: US 2016/0016064 A1
(43) Pub. Date: Jan. 21, 2016

(54) A Method of Online and Offline Implementation of a Mini-Soccer Match

(71) Applicant: Xiaoyan LIU, Shanghai (CN)

(72) Inventor: Xiaoyan Liu, Shanghai (CN)

(21) Appl. No.: 14/773,344

(22) PCT Filed: Mar. 7, 2014
(86) PCT No.: PCT/CN2014/073038

§ 371 Date: Sep. 6, 2015

(30) Foreign Application Priority Data
Mar. 8, 2013 (CN) 201310074361.6

(51) Int. Cl. A63B 71/06; H04W 60/00; A63B 24/00

(52) U.S. Cl. CPC A63B 71/0616; A63B 24/0062; A63B 71/06; H04W 60/00; A63B 2024/0056; H04W 88/02

(57) ABSTRACT

A method of online and offline implementation of a mini-soccer match characterized in that: the method includes at least the following steps: set up a venue, which includes a flat ground and two goals; the venue is provided with a terminal device, which has functions of collection and statistics of the real-time data of the match, and has functions of being connected to the Internet and uploading data; at least one server is provided, which has at least one memory module, a wireless transmission module, and a downloadable and editable application program; the wireless transmission module is connected to the memory module and the terminal device through the Internet; and the application program includes at least one registration program. The present invention has the following advantages: the soccer field, the soccer match, and the network interaction are combined to form a new type of soccer match.

### BACKGROUND OF THE INVENTION

1. Field of Invention

The present invention relates to the field of sport, in particular to online and offline implementation of a mini-soccer match.

2. Related Art

Soccer is the world's most influential and most popular sport and is widely played in the world. It is not only a combination of the characteristics of different human sports, but is also funny and competitive, benefiting the improvement of the physical fitness of the players and development of friendships in the teams.

However, due to the rapid growth of economy, more and more sports venues are replaced with buildings, leading to less soccer fields. Because of decrease of soccer fields, street soccer, which is another way to show personal skills of soccer, becomes more popular in the cities around the world. Compared to the traditional soccer match, street soccer lacks a unified organization and effective planning and, therefore, is problematic in recruiting players, searching venue, and specifying the game rules. For example, the players have to agree on a match time, and occurrence of unexpected events might cause cancel of the match; the venue needs to be booked in advance; street soccer has different rules, and undetermined rules will make people not able to properly participate in such match and, therefore, leads to abandon of the match. Up to now, there is still no method for achieving online and offline implementation of soccer for making people enjoy soccer.

### SUMMARY OF THE INVENTION

In view of the above-described problems, it is one objective of the invention to provide a method of online and offline implementation of a mini-soccer match. The method allows for submission of registration information to a server in advance via a terminal device or registration via a registration terminal at a venue; and the venue can be set up before match and simply removed after the match. As such, the method allows people enjoy soccer simply.

For the purpose of the invention, there is provide a method of online and offline implementation of a mini-soccer match. The method comprises:

setting up a venue, wherein the venue comprises a flat ground and two goals;

the venue is provided with a terminal device, and the terminal device has functions of collection and statistics of real-time data of the match and has functions of being connected with the Internet and uploading data; and

at least one server is provided, the server has at least one memory module, a wireless transmission module, an ID reading module, and a downloadable and editable application program or an ID data; the wireless transmission module is connected to the ID reading module and the memory module; the wireless transmission module is connected to the terminal device through the Internet; the application program includes at least one registration program; and the application program or the ID data is connected to the ID reading module through the Internet

In a class of this embodiment, the venue comprises a registration terminal comprising the application program and a part of the ID data.

In a class of this embodiment, the terminal device downloads the application program via the Internet and edits registration information in the registration program, and then sends the registration information to the server.

In a class of this embodiment, side walls of the venue are produced from a flexible material; the venue is a closed ring-shaped area; and the two goals are on opposite sides of the closed ring-shaped area.

In a class of this embodiment, terminal device has at least scoring function, timing function, and video recording function; the scoring function and the timing function are for recording data of the soccer match; the video recording function is for recording a video of the soccer match; the terminal device uploads the data and video through the Internet to the server.

In a class of this embodiment, the data includes at least numbers of goals, nutmegs, and fouls.

In a class of this embodiment, the application program or the ID data comprises ID information of the players of the soccer match.

In a class of this embodiment, the ID data is a two-dimensional code of the ID information of the players of the soccer match or a personal account stored in the memory module and corresponding to the ID information of the players.

The present invention has the following advantages: registration is simple; the venue is a microcosm of a formal soccer field and can be seamlessly combined with a large venue, which reduces venue requirements and is easy to use; and players play offline and record online so that the soccer field, the soccer match, and the network interaction are combined to form a new type of soccer match.

The new type of soccer match is free and skillful, can be easily enjoyed by more people and inspires the potential of the domestic soccer market; and it can be used to train more skilled reserve players for the Chinese soccer.

### BRIEF DESCRIPTION OF THE DRAWINGS

FIG. 1 is a flow chart of one preferred embodiment of the present invention.

FIG. 2 is a flow chart of another preferred embodiment of the present invention.

FIG. 3 is a schematic view of the venue of the present invention.

### DETAILED DESCRIPTION OF THE INVENTION

The present invention will be described in further detail in accordance with the figures.

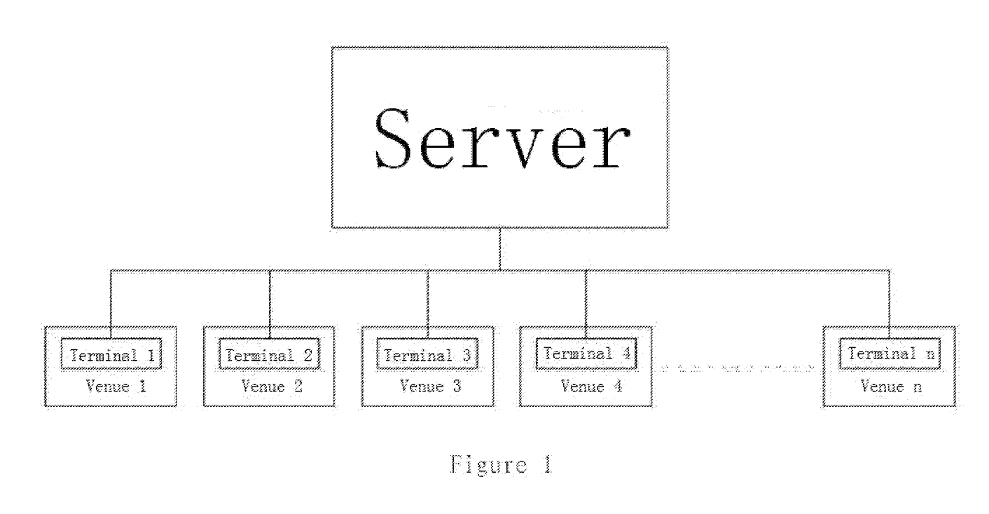

In FIGS. 1-3, the reference numbers are venue 1, side wall 2, and goal 3.

### First Preferred Embodiment

In an online and offline implementation of a mini-soccer match, the players register online; after playing the match offline, the game result is uploaded online for statistics and online ranking. For example, the match is carried out at the venue one member or two members per side; the match time is three minutes; a goal scores two points; and a nutmeg scores one point. In normal circumstances, the team scoring more wins. However, if one team nutmegs and controls the ball before the ball hits the side wall of the venue, this team wins.

As shown in FIG. 1, implementation of the mini-soccer match includes the following steps:

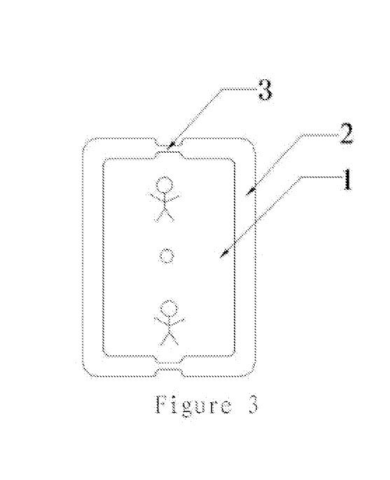

selecting and setting up a venue: as shown in FIG. 3, the basic requirement is to establish venue 1 within a flat ground, and two goals are set in venue 1. It is preferred that the venue 1 is surrounded by baffles, screens, or other flexible materials as the side wall 2 so as to allow match carried out in a predetermined area and to sufficiently reduce shocks to the players when knocking at the side wall 2 for avoiding injury.

One server is provided for recording the game. The server includes one memory module, a wireless transmission module, and a downloadable and editable application program (i.e., APP) or ID data. The application program has registration function and can be downloaded to the terminal equipment (such as a mobile phone, tablet PC, laptop, etc.) of each player; the wireless transmission module receives the registration information edited by the player using the application program via the Internet and stores it in the server so as to realize online registration. The registration information also includes the ID information of the player, and the player can edit the ID information via managing the corresponding personal account; when the player uses the application program to register, he can log in his personal account to conduct the operation. The ID data may be a two-dimensional code of the ID information. When the player brings the two-dimensional code of his ID information to the venue 1, the terminal device can be used to scan the two-dimensional code so as to record the ID information of the player (including information of participation, referee, ranking, etc.) in the server for subsequent matches and ranking. The player can bring the ID information to any venue 1 and scans the two-dimensional code using the terminal within the venue 1 for registration and ranking, etc., which allows the player to freely choose the venue 1 and the corresponding game.

A terminal device for wireless data exchange with the server is provided in each venue 1. The terminal device in the embodiment is a device for statistics of the data and result of the soccer match and has a connection to the Internet for uploading the data. The device is equivalent to a referee device having wireless transmission function, scoring function, timing function, video recording function, and other functions. A referee uses the scoring function and timing function to record the match data of the venue 1, such as a goal scoring two points and a nutmeg scoring one point; the video recording function is for recording a video of the match; the wireless transmission function is for transferring the scores, the match result, and the video to the server for data update. In additional, the wireless transmission function can also be used to upload the match video to video-sharing website, microblogging, and other media website for online interaction.

### Second Preferred Embodiment

This embodiment is different from the first embodiment in that:

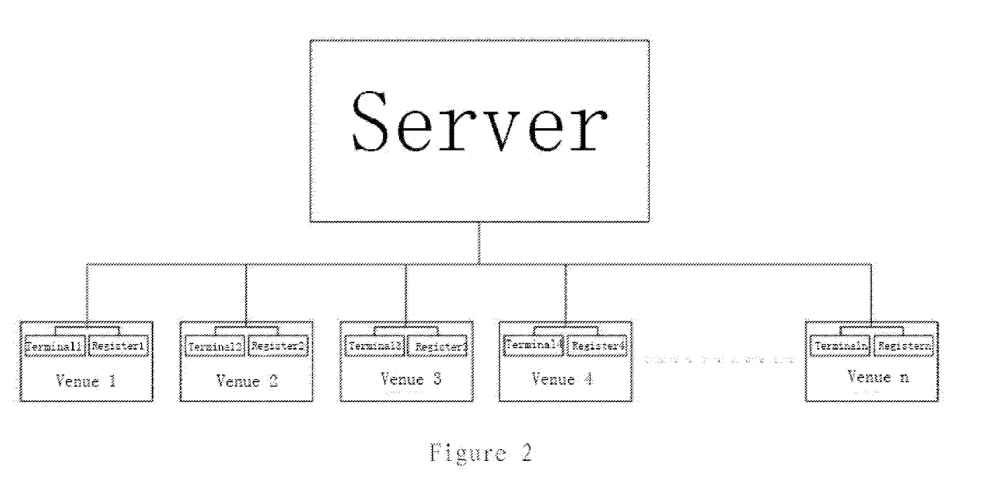

As shown in FIG. 2, the venue 1 further includes a registration device. The registration device is a registration terminal that downloads the application program from the server for offline registration of the players.

In the afore-mentioned examples:

The application program downloadable from the server can have registration, referee, and video recording functions. The registration of the player automatically generates a micro-blogging. The referee only need to click the keys on the terminal device for enforcement of the rules; goals, nutmegs, fouls, etc. are clearly recorded; the video recorded can be easily uploaded to video-sharing website to save labor. The application program can also record the number of players and matches, the match time, and other data including win, tie, defeat of each player.

In addition, video and audio equipment might be provided in the venue 1, including stereo set and large display for music and live broadcasting, which results in an online and offline technical combination of match.

The match data will be immediately uploaded to the network and displayed in each player's personal webpage for social interaction and match appointment with other users on the server. Players on the server can be graded by match results and is upgraded when wining more matches. The upgrading of the player occurs when participating more matches and increasing the personal skill, which increases the player's interest in match.

1. A method of online and offline implementation of a mini-soccer match, comprising:
setting up a venue, the venue having a flat ground and two goals;
providing the venue with a terminal device, the terminal device collects and analyzes real-time data of the match and the terminal device connects with the Internet and uploads data; and
providing at least one server, the server having at least one memory module, a wireless transmission module, and a downloadable and editable application program;
wherein the wireless transmission module is connected to the memory module, the wireless transmission module is connected to the terminal device through the Internet, and the application program includes at least one registration program.

2. The method of claim 1, wherein the venue comprises a registration terminal.

3. The method of claim 1, wherein the terminal device downloads the application program via the Internet and edits registration information in the registration program, and then sends the registration information to the server.

4. The method of claim 1, wherein:
side walls of the venue are produced from a flexible material;
the venue is a closed ring-shaped area; and
the two goals are on opposite sides of the closed ring-shaped area.

5. The method of claim 1, wherein:
the terminal device has a scoring function, a timing function, and a video recording function;
the scoring function and the timing function record data of the soccer match;
the video recording function records a video of the soccer match; and
the terminal device uploads the data and the video through the Internet to the server.

6. The method of claim 1, wherein the data includes numbers of goals, nutmegs, and fouls.

7. The method of claim 1, wherein the mini-soccer match has no more than five players per side.

8. The method of claim 2, wherein the terminal device downloads the application program via the Internet and edits registration information in the registration program, and then sends the registration information to the server.

9. The method of claim 8, wherein:
the terminal device has a scoring function, a timing function, and a video recording function;
the scoring function and the timing function record data of the soccer match;
the video recording function records a video of the soccer match; and
the terminal device uploads the data and the video through the Internet to the server.

10. The method of claim 9, wherein the mini-soccer match has no more than five players per side.
